(19) United States
(12) Patent Application Publication
(10) Pub. No.: US 2021/0390556 A1
(43) Pub. Date: Dec. 16, 2021

(54) SYSTEMS AND METHODS FOR AGE VERIFICATION

(71) Applicant: Capital One Services, LLC, McLean, VA (US)

(72) Inventor: Sophie BERMUDEZ, Washington, DC (US)

(21) Appl. No.: 16/902,642

(22) Filed: Jun. 16, 2020

(51) Int. Cl. G06Q 30/00; G06Q 50/26; G06Q 30/06; G06Q 40/02; G06Q 20/08; G06Q 20/40; G06Q 20/20; G06Q 20/34; G06Q 20/22; G06F 9/54

(52) U.S. Cl. CPC G06Q 30/0185; G06Q 50/265; G06Q 30/0607; G06Q 40/02; G06Q 20/085; G06Q 20/405; G06F 9/547; G06Q 20/206; G06Q 20/341; G06Q 20/4015; G06Q 20/2295; G06Q 20/40145; G06Q 20/202

(57) ABSTRACT

A card holder's verified date of birth can be stored in a system and a verification communication link can be used for an age verification check using a required age and the card holder's verified date of birth. A verification cache can be used so that any age verification check can be done on a per transaction basis. The first setting of the verification cache can trigger the age verification check on the verification communication link while a transaction is processed on another communication link.

### FIELD OF THE INVENTION

The present disclosure generally relates to improved speed and accuracy for age verification and, in particular, to systems and methods for age verification with improved speed, accuracy and cost-effectiveness.

### BACKGROUND

The convenience and ease of online purchases and automated payment systems has created a demand for improvements in age verification for age-restricted products and services such as e-cigarettes, alcohol, dating applications, entertainment, ticketed events, and so on. When under-aged consumers make purchases, retail shops and service providers can face serious repercussions such as regulatory fines, legal issues, and reputational harm requiring expensive public relations. Businesses may have a duty to perform due diligence to verify the age of visitors before they make purchases.

Some existing age verification systems and methods are unwieldy or have slow processing times, which can reduce the conversion rate for businesses. Verifying the user's age can be inconvenient and harm the user experience. Bad age verification practices can result in accidental fraud and chargebacks. Under-aged consumers may obtain harmful substances and businesses may face legal and financial repercussions. Some age verification methods may not be fool-proof and rely on inaccurate information like fake driver's licenses. In addition, some age verification methods could violate privacy rights.

Accordingly, there are significant, and competing, needs to improve the speed, accuracy, and cost-effectiveness of age verification.

### SUMMARY

Example embodiments of the present disclosure are directed to systems and methods for age verification that satisfy these needs. Systems and methods according to example embodiments can provide effective and efficient ways to perform age verification. In doing so, these systems and methods can meet the increasing demand for age verification with a high degree of accuracy in a quick and cost-effective manner. For example, embodiments of the present disclosure can assist a business in the diligent application of age-related laws and regulations, and in doing so can help a business avoid potential legal and regulatory issues, such as fines and forced closures, and reputational harm. Example embodiments can provide age verification in an expedient manner that does not degrade the experience of customers seeking to purchase age-restricted items or diminish the potential of a business to make sales of age-restricted items. Example embodiments of the present disclosure can also improve accuracy and reliability of age verification by reducing the potential for fake or forged identity documents to pass the verification. Example embodiments can further reduce the need for businesses to dedicate time and resources, including the time of paid personnel, to enforcing age verification.

Example embodiments of the present disclosure can benefit consumers as well as businesses. For example, by facilitating expedient age verification, the experience of consumers seeking to purchase age-restricted items can be improved, along with the experience of consumers around them (e.g., consumers waiting in line behind a person making an age-restricted purchase). By providing a more secure and accurate age verification can result in the diversion of individuals seeking to make illegitimate purchases away from the business, improving safety and reducing the need for intervention by business staff or law enforcement. Further, by reducing access by under-age individuals to age-restricted items can improve the general health and safety of those individuals. As another example, age verification according to example embodiments can reduce the need for consumers to present identification or other sensitive personal information in public or to business personnel, which can reduce the risk of identity theft and fraud.

An example embodiment of the present disclosure can be a system. The system can comprise a server, a data storage, and an application programming interface (API). The server can have a processor and a transaction communication link. The data storage can be accessible by the server. The data storage can store card holder account information. The API can be executable by the processor and in data communication with the data storage and the transaction communication link. The API can be configured to perform a method. A card holder's verified date of birth can be stored for an account associated with the card holder. The payer's card information can be received. The account associated with the card holder can be determined from the payer's card information. An age verification check including a required age can be received. It can be determined whether the card holder passes the age verification check using the required age and the card holder's verified date of birth. A payment request identifying the payer can be received. In response to the payment request, it can be determined whether the card holder is the payer. The server can further comprise a verification communication link, where the API has access to the verification communication link and is further configured to open the verification communication link in response to receiving the payer's card information. The age verification check can be received on the verification communication link. The API can be further configured to send a notification of whether the card holder passes the age verification check via the verification communication link. The server can be connected by the transaction communication link to a merchant system. The merchant system can include a point of sale terminal. The server can be connected by the verification communication link to the point of sale terminal. The point of sale terminal can store a verification cache that indicates whether the age verification check is needed on a per transaction basis. The first setting of the verification cache can trigger the point of sale terminal to send the age verification check to the server.

An example embodiment of the present disclosure can be a method. A verified credential for an account associated with a card holder can be stored. Payer card information associated with a payer can be received. The account associated with the card holder from the payer card information can be identified. A verification check including a required credential can be received. It can be determined whether the card holder passes the verification check using the required credential and the card holder's verified credential. A payment request can be received. It can be determined whether the payer is the card holder, in response to the payment request. Prior to receiving the payment request, a notification of whether the card holder passes the age verification check can be sent. The verified credential can be a verified date of birth, the verification check can be an age verification check, and the required credential can be a required age. The verified credential can be a verified identification credential, the verification check can be an identity check, and the required credential can be a required identity. The verification check can comprise inventory data and a merchant location and the required credential can be interpreted using the inventory data and the merchant location. The age verification check can include a merchant location and authenticating whether the payer is the card holder can include receiving a payer location from a mobile device and comparing the payer location with the merchant location. It can be determined whether the payer is the card holder by two-factor authentication. It can be determined whether the payer is the card holder by authentication by a parent when the parent is the card holder and the payer is a child, when the parent is in a different location from the child. It can be determined whether the payer is the card holder using a biometric test. The biometric test can be a fingerprint. The verification check can be a code identifying the required credential.

An example embodiment of the present disclosure can be a system that comprises a server, a data storage, a merchant system and an API. The server can have a processor, a transaction communication link, and a verification communication link. The data storage can be accessible by the server and the data storage can store card holder account information. The merchant system can have a point of sale terminal. The point of sale terminal can be connected to the transaction communication link and the verification communication link. The API can be executable by the processor and in data communication with the data storage, the transaction communication link, and the verification communication link. The API can be configured to perform a method. A card holder's verified date of birth for an account associated with the card holder can be stored. Payer card information associated with a payer can be received. The verification communication link can be opened in response to receiving the payer card information. The account of the card holder can be determined from the payer card information. An age verification check can be received on the verification communication link. The age verification check can include a required age. It can be determined whether the card holder passes the age verification check using the required age and the card holder's verified date of birth. A notification of whether the card holder passes the age verification check can be sent. The notification can be sent on the verification communication link. A payment request can be received. It can be authenticated that the payer is the card holder, in response to the payment request. The point of sale terminal can store a verification cache. The verification cache can indicate whether the age verification check is needed on a per transaction basis. The first setting of the verification cache can trigger the point of sale terminal to send the age verification check to the server.

These and other features, aspects and advantages of the disclosed subject matter are explained in greater detail with reference to specific example embodiments that are illustrated in the following description, appended claims, and accompanying drawings, in which like elements are indicated with like reference designators.

### BRIEF DESCRIPTION OF THE DRAWINGS

FIG. 1 is a diagram of a system for age verification, according to an example embodiment of the disclosure.

FIG. 2 is a diagram of a system for age verification, according to an example embodiment of the disclosure.

FIG. 3 is a flow chart of a method for age verification, according to an example embodiment of the disclosure.

FIG. 4 is a diagram of a system for age verification, according to an example embodiment of the disclosure.

FIG. 5 is a flow chart of a method for age verification, according to an example embodiment of the disclosure.

FIG. 6 is a diagram of a system for age verification, according to an example embodiment of the disclosure.

### DETAILED DESCRIPTION OF EXAMPLE EMBODIMENTS

The following description of embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

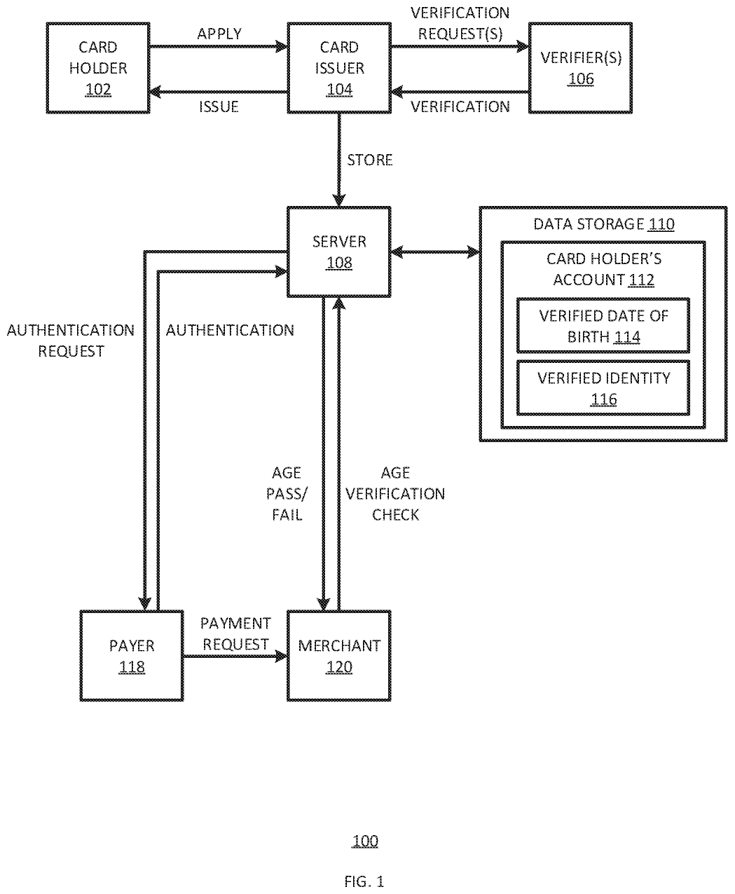

FIG. 1 is a diagram of a system 100 for age verification, according to an example embodiment of the disclosure. System 100 can be used for age-restricted products or services such as e-cigarettes, alcohol, dating applications, entertainment, ticketed events, and so on. System 100 can facilitate interactions between multiple participants including a card holder 102, a card issuer 104, a verifier 106, a payer 118, and a merchant 120. For example, merchant 120 may need to verify the age of payer 118 who presents a card to purchase an age-restricted product, such as cigarettes. System 100 can allow merchant 120 to rely on credentials that were previously established by card holder 102, card issuer 104 and verifier 106. System 100 can include establishing reliable credentials for age, identity or other verification through an application process that results in one or more reliable credentials being associated with card holder 102.

Card holder 102 can be any person who has successfully applied to a card issuer 104 for a card. The card can be a smartcard, an access card, an identity card, a credit card, a multi-purpose card, a virtual card, or any kind of card or device associated with an account that may need age verification in some kinds of transactions. For example, basic requirements for approving an application for a credit card can include being at least 21 years old or 18 with either a parent's permission or a verifiable source of income, having a social security number, having a source of income, and having a positive credit history. Typically, a credit card application includes information such as name, address, phone number, citizenship, date of birth, gross annual income, monthly housing payment, time at current residence, authorized users, and may include additional information. An adult with a steady job, a credit report showing on-time payments, and a good credit score is likely to be approved for a credit card. For example, an office building security card may be contingent on the approval by a human resources department for onboarding a new employee, which typically includes the new employee submitting a complete and correct Form I-9 and the human resources department obtaining copies of identification within the first few days of work. Form I-9 acceptable documents may include a U.S. passport, a permanent resident card or alien registration receipt card, employment authorization document card, foreign passport, driver's license, identification card issued by federal, state, or local government agencies or entities, school identification card, voter registration card, U.S. military card, social security card, birth certificate, consular report of birth abroad, and other documents.

Card issuer 104 receives an application from card holder 102, verifies information about card issuer 104 with one or more verifier 106, issues a card to card holder 102, and sends information about card holder 102, the issued card and the associated account to server 108 for storing in data storage 110. Card issuer 104 can be a bank, a credit union, an organization, a business, an agent, a government entity, or any other entity that issues cards that are capable of facilitating age verification in some kinds of transactions. For example, card issuer 104 may be a bank that approved an application for a credit card from card holder 102, after verifying the identity and age of card holder 102 by contacting one or more verifier 106 such as the Social Security Administration, state department of motor vehicles, and credit card bureaus. For example, card issuer 104 may be a business or place such as a gas station, a public transportation system, or a liquor store that approved an application and issued a smartcard for a specific use, after verifying the identity and age of card holder 102 in a way similar to that used by a bank approving a credit card. Card issuer 104 can contact one or more verifier 106 to verify the applicant's age and other information in the application, such as name, address, phone number, and checking account information. For example, card issuer 104 can contact a state department of motor vehicles as a verifier 106 to verify name, address, and phone number. Card issuer 104 can contact a bank as a verifier 106 to verify checking account information such as a checking account number, available funds, billing address, and other information. Card issuer 104 and verifier 106 can be people that both work at the same bank, for example.

Verifier 106 may be a bank, a credit reporting bureau, a government administrator, an employer, a lender, or any other entity with access to reliable information. Verifier 106 may use various sources of reliable information to verify information such as credit reports, credit scores, public records, birth certificates, social security numbers, driver license, identification card, passport, and any other documents, proof, or evidence. Card issuer 104 and/or verifier 106 can employ more or less rigorous or sophisticated screening processes, formulas, or tests, before deciding to extend card holder 102 a credit offer, credit account or any decision about issuing any kind of card associated with an account. For example, a federally compliant driver license and identification card such as a “Real ID” requires three categories of verification: proof of identity, proof of social security number, and proof of current residency. In general, a driver license/identification card application may include information such as name, address, date of birth, social security number, citizenship, gender, weight, height, hair color, eye color, other names used, phone, email, driving history, medical history, preferences, voter registration, and may include other information. Driver license/identification card applicants may provide proof of identity, social security number, and current residency by presenting documents to a department of motor vehicles such as passports, birth certificates, consular report of birth abroad, unexpired permanent resident card, certificate of naturalization, certificate of citizenship, visa, employment authorization card, driver license, learner permit, identification card, name change certified marriage certificate, social security card, utility bill, telephone bill, deed, mortgage, lease, insurance policy, bank account statement, and other kinds of proof. For example, a human resources department may use E-Verify to verify the identity of a new employee, which matches information on Form I-9 with government records available to the Social Security Administration and the Department of Homeland Security.

After verification, card issuer 104 can contact a server 108 to store a card holder's account 112 with a verified date of birth 114 and a verified identity 115 in a data storage 110 and issue a card to card holder 102. Data storage 110 can be any organized collection of data such as a relational database. Data storage 110 can be a part of server 108 or accessible by server 108 via a network. Data storage 110 can hold records for various kinds of accounts such as bank accounts, deposit accounts, checking accounts, credit card accounts, loan accounts, payment card accounts, investment accounts, brokerage accounts, and accounts associated with other products or services such as a smartcard for public transport payment or office building access. For example, one of the records in data storage 110 may be card holder's account 112, which may be associated with a credit card issued by a bank. Card holder's account 112 may include data such as a card name, an annual percentage rate, an interest rate, a percentage of cashback, a grace period, a payment type, an annual fee, a currency, a current balance, a minimum payment, a minimum amount, a maximum amount, contactless payment option, and other data associated with the credit card issued by the bank. Card holder's account 112 may include data that was collected and/or verified during the application process, before the card was issued such as verified date of birth 114 and verified identity 116. For example, card holder 102 may be a current credit card customer of a bank that verified the customer's date of birth and identity. For example, verified date of birth 114 may be a date and verified identity 116 may be a name, address, and social security number. Card holder's account 112 may include supporting proof or evidence used in the verification such as a copy of a social security card, birth certificate, or driver license. Card holder's account 112 may include other kinds of verified credentials for various kinds of cards and accounts.

After the card is issued, the card can be used in a transaction between a payer 118 and a merchant 120 where an age verification is needed. For example, a current credit card customer may present their card at a liquor store to make a purchase requiring age verification. When payer 118 uses the card, merchant 120 can contact server 108 to determine whether payer 118 passes the age verification check and to process or approve the transaction, which may include server 108 authenticating that payer 118 is card holder 102 of card holder's account 112. For example, payer 118 taps a card on retail checkout equipment while a grocery order including a bottle of wine is being checked out. The retail checkout equipment alerts merchant 120 that the bottle of wine is an age-restricted product based on stock keeping unit (SKU) or inventory tracking information such as that obtained from scanning a barcode. Merchant 120 can send an age verification check to server 108 with an age requirement such as 18 or 21. Server 108 can receive card information from payer 118 and match it to card holder's account 112 to determine that payer 118 is the same person as card holder 102. For example, the card information from payer 118 may include a credit card number, a card expiration date, a billing address, a card security code, a payment amount, a location, a merchant code, and other information related to payer 118, the transaction, merchant 120, or the credit card. Server 108 can determine that the card holder's verified date of birth 114 meets the age requirement for the transaction. For example, server 108 can use database queries, match the payer's card information with the card holder's account 112 stored in data storage 110 for card holder 102, and determine that the age requirement is met with calculations using the verified date of birth 114. Merchant 120 can receive notice from server 108 that payer 118 passes the age verification check and approval for the transaction.

Approval for the transaction may include server 108 sending an authentication request to payer 118 and receiving authentication in response. For example, credit card authentication may be a process that confirms the customer's credit card with the card issuer 104 and/or server 108. Generally, credit card authentication occurs during the transaction communication process, which involves transmitting the card information to the card issuer 104 through a payment processor for authentication.

In an electronic payment transaction, various entities may be involved such as the merchant 120, a merchant acquiring bank, a network processor and the card issuer 104. For example, card issuer 104 may provide approval of the card transaction for authentication by interacting with server 108 and server 108 may interact with the merchant 120, the merchant acquiring bank, and the network processor. Once authenticated, the merchant acquiring bank may receive the communication from the network processor and authorize the transaction for payment acceptance and account deposit. When payer 118 swipes a credit card, the details of the transaction can be entered electronically and sent to the merchant acquiring bank, which facilitates the transaction processing and settles the funds for a deposit. The merchant acquiring bank can transmit transaction details to the card issuer 104 though the network processor for the authentication. The card issuer 104 can check various card details such as card number, card type, card security code, and billing address to ensure accuracy. For example, server 108 can interact with the card issuer 104 and other entities, access the card holder's account 112, and match the card information presented by the payer 118 to the merchant 120 to the card information for the card holder's account 112 to authenticate that the payer 118 is the card holder 102. The card issuer 104 and/or the server 108 can have various procedures that ensure that a transaction is not fraudulent to protect the security of the card holder 102. The authentication process can help to prevent chargebacks and protect the merchant 120 from any funding issues.

In a conventional credit card transaction process, authorization is may typically be the final step. Once the card has been authenticated, the card issuer 104 can send the authentication to the merchant acquiring bank through the network processor. The merchant acquiring bank can receive the communication and authorize the payment for the merchant 120. If payment is not authenticated, the merchant acquiring bank can decline the transaction. While extensive communication can be required for the completion of a transaction, transaction processing may be completed in a matter of seconds. The final authorization process can allow the merchant acquiring bank to initiate a payment deposit in the merchant's account. In a credit card transaction, the merchant acquiring bank can also be the settlement bank, receiving the payment funds and depositing them in the merchant account. The merchant acquiring bank typically charge merchants both transaction fees and monthly account fees. Transaction fees can compensate the merchant bank for facilitating the communication. Merchant acquiring banks can also cover the risks of any issues arising with non-settlement, chargebacks, and refunds.

Server 108 can be a network-enabled computer. As referred to herein, a network-enabled computer may include, but is not limited to a computer device, or communications device including, e.g., a server, a network appliance, a personal computer, a workstation, a phone, a handheld PC, a personal digital assistant, a thin client, a fat client, an Internet browser, a mobile device, or other device. For example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

A network-enabled computer can include a processor and a memory, and it is understood that the processing circuitry may contain additional components, including processors, memories, error and parity/CRC checkers, data encoders, anti-collision algorithms, controllers, command decoders, security primitives and tamper-proofing hardware, as necessary to perform the functions described herein.

A network-enabled computer can include a display and input devices. The display can be any type of device for presenting visual information such as a computer monitor, a flat panel display, and a mobile device screen, including liquid crystal displays, light-emitting diode displays, plasma panels, and cathode ray tube displays. The input devices can include any device for entering information into the user's device that is available and supported by the user's device, such as a touch-screen, keyboard, mouse, cursor-control device, touch-screen, microphone, digital camera, video recorder or camcorder. These devices can be used to enter information and interact with the software and other devices described herein. In some examples, the network-enabled computer can execute one or more applications, such as software applications, that enable, for example, network communications with one or more components of the system and transmit and/or receive data.

A network-enabled computer can be a client device in communication with one or more servers via one or more networks, and can operate as a respective front-end to back-end pair with the server. A client device can transmit, for example from a mobile device application executing on the client device, one or more requests to the server. The one or more requests can be associated with retrieving data from the server. The server can receive the one or more requests from the client device. Based on the one or more requests from the client device, the server can be configured to retrieve the requested data from one or more databases or other data storage devices associated with or accessibly by the server. Based on receipt of the requested data from the one or more databases, the server can be configured to transmit the received data to the client device. For example, the received data can be responsive to one or more requests.

The network can be one or more of a wireless network, a wired network or any combination of wireless network and wired network, and can be configured to connect the client device to the server. For example, the network can include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

The network can include, without limitation, telephone lines, fiber optics, IEEE Ethernet 902.3, a wide area network, a wireless personal area network, a LAN, or a global network such as the Internet. The network can support an Internet network, a wireless communication network, a cellular network, or the like, or any combination thereof. The network can further include one network, or any number of the exemplary types of networks mentioned above, operating as a stand-alone network or in cooperation with each other. The network can utilize one or more protocols of one or more network elements to which they are communicatively coupled. The network can translate to or from other protocols to one or more protocols of network devices. Although the network is depicted as a single network, it should be appreciated that according to one or more examples, the network can comprise any number of interconnected networks, such as, for example, the Internet, a service provider's network, a cable television network, corporate networks, such as credit card association networks, and home networks.

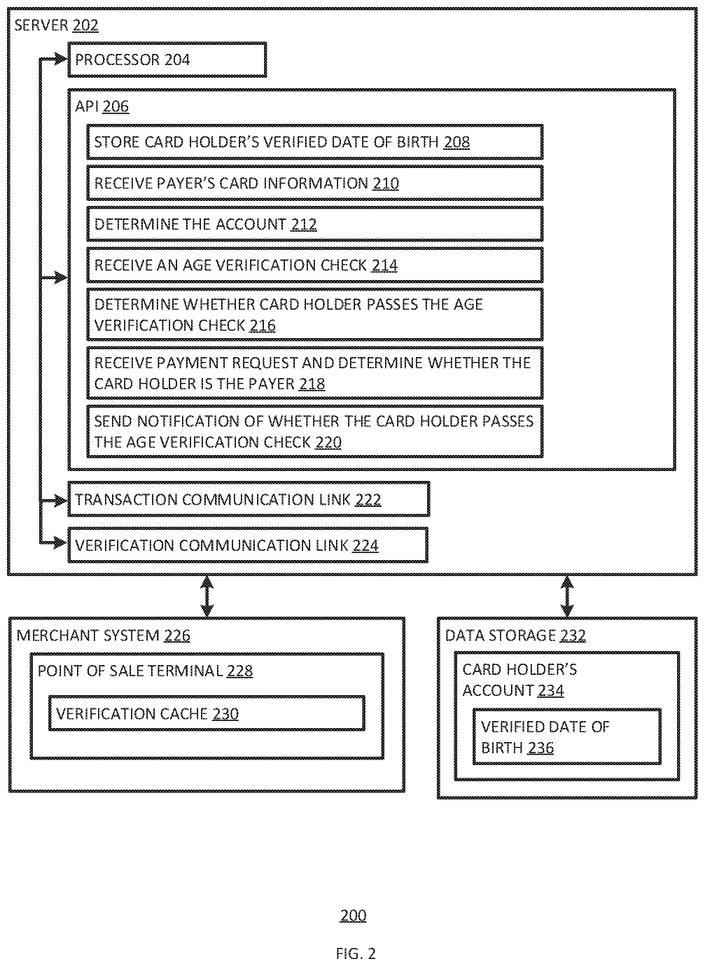

FIG. 2 is a diagram of a system 200 for age verification, according to an example embodiment of the disclosure. System 200 can be a centralized payments hub for processing payments, checks, credit cards, wire transfers, automated clearing house transactions, and other kinds of payments and transactions that involve merchants and card holders. System 200 can facilitate age verification or the verification of other verifiable credentials that may be associated with an account. System 200 can include a server 202 in data communication with a merchant system 226 and a data storage 232. Server 202 can be a network-enabled computer and include a processor 204, an application programming interface (API) 206, a transaction communication link 222, and a verification communication link 224. API 206 can be executable by the processor and in data communication with data storage 232 and merchant system 226.

Server 202 can be connected by transaction communication link 222 and verification communication link 224 to merchant system 226. Transaction communication link 222 and verification communication link 224 can be any kind of physical communication links in any kind of network that connects server 202 to merchant system 226. These communication links can include data link control, i.e., various kinds of point-to-point protocols to control the passage of data over communication links. Any kind of point-to-point protocol at the network, transport, and physical layers may be used. These communication links can have different purposes in system 200. Transaction communication link 222 can be used for the purpose of processing transactions, while verification communication link 224 can be used for the purpose of verifying a credential, such as age. By offloading age verification communication between server 202 and merchant system 226 to verification communication link 224, regular transaction processing on transaction communication link 222 will not be slowed and may proceed in parallel.

Merchant system 226 can be a network-enabled computer and include or be in data communication with a point of sale terminal 228. Server 202 can be connected by transaction communication link 222 and verification communication link 224 to merchant system 226 and/or point of sale terminal 228. Merchant system 226 and/or point of sale terminal 228 can include a verification cache 230.

Verification cache 230 can be a data storage with quick access for communication with server 202 over verification communication link 224. Verification cache 230 can be a hardware or software component that stores data so that future requests for that data can be accessed faster. Data stored in verification cache 230 can be the result of an earlier use of data associated with verifying a credential in system 200 such as an age verification check. Verification cache 230 can indicate whether the age verification check is needed on a per transaction basis. Verification cache 230 can include a flag that may be cleared before each transaction and then set once during a transaction if any item needs an age verification check. The first setting of verification cache 230 can trigger point of sale terminal 228 to send the age verification check to server 202. Verification cache 230 can include one or more required age(s) for the age verification check(s).

Data storage 232 can store card holder account information for a number of accounts and a number of card holders. One of the accounts can be a card holder's account 234 having a verified date of birth 236. Data storage 232 can be any kind of organized memory unit, such as a relational database management system.

API 206 can be an interface and/or communication protocol that facilitates communication between server 202 and merchant system 226. API 206 can be association with a software development kit (SDK) and can allow access to features and data for verification of a credential such as an age verification check. API 206 can be configured to perform various methods, tasks, interfaces, or functions in conjunction with processor 204, transaction communication link 222 and verification communication link 224 of server 202. API 206 or parts of API 206 can be exposed as web services, made available on a private network, or made part of another payment API. A card holder's verified date of birth can be stored for an account associated with the card holder 208. The payer's card information can be received 210 via the transaction communication link 222. In response to receiving the payer's card information 210, verification communication link 224 can be opened. The account associated with the card holder can be determined 212 from the payer's card information. An age verification check including a required age can be received 214 via the verification communication link. It can be determined whether the card holder passes the age verification check 216 using the required age and the card holder's verified date of birth. A payment request identifying the payer can be received via the transaction communication link 222. In response to the payment request, it can be determined whether the card holder is the payer 218. A notification of whether the card holder passes the age verification check 220 can be sent via the verification communication link 224 to merchant system 226. For example, if the card holder is older than the required age, the card holder passes the verification check. Similarly, if the card holder is not older (i.e., is younger) than the required age, the card holder does not pass the verification check.

For example, an applicant applies for a credit card online and an employee at a credit card company approves the application, issues a credit card, and uses API 206 to store the new card holder's verified data of birth 236 in data storage 232. This new card holder uses the credit card to purchase R-rated movie theater tickets online using merchant system 226. Merchant system 226 sets a flag in verification cache 230 indicating that the R-rated movie theater tickets need an age verification check. Server 202 and merchant system 226 communicate over verification communication link 224 using API 206 to receive the age verification check 214, determine whether the card holder passes the age verification check 216, and send a notification of whether the card holder passes the age verification check 220. While the age verification check is happening on the verification link, server 202 and merchant system 226 communicate over transaction communication link 222 using API 206 to receive the payer's card information 210, determine the card holder's account 212, receive the payment request and determine whether the card holder is the payer 218. If the transaction is approved first, server 202 can be configured to wait for the age verification check before sending the approval over the transaction communication link 222 or merchant system 226 or point of sale terminal 228 can wait for the age verification check. Verification cache 230 can use flags, counters and/or timers to keep track of the age verification notice and the transaction approval notice and decide whether to wait or take another action such as resending the age verification check or asking the payer directly. Whether the age verification check is passed and the R-rated movie theater tickets are purchased or whether the age verification check is failed and the ticket purchase is declined, reliable and accurate information can be used, the good reputation of the movie theater can be enhanced, and a compliance record can be stored for the movie theater. Similarly, if merchant system is an in-person box office or self-service kiosk in a movie theater, time and labor can be saved by automating manual age verification checks.

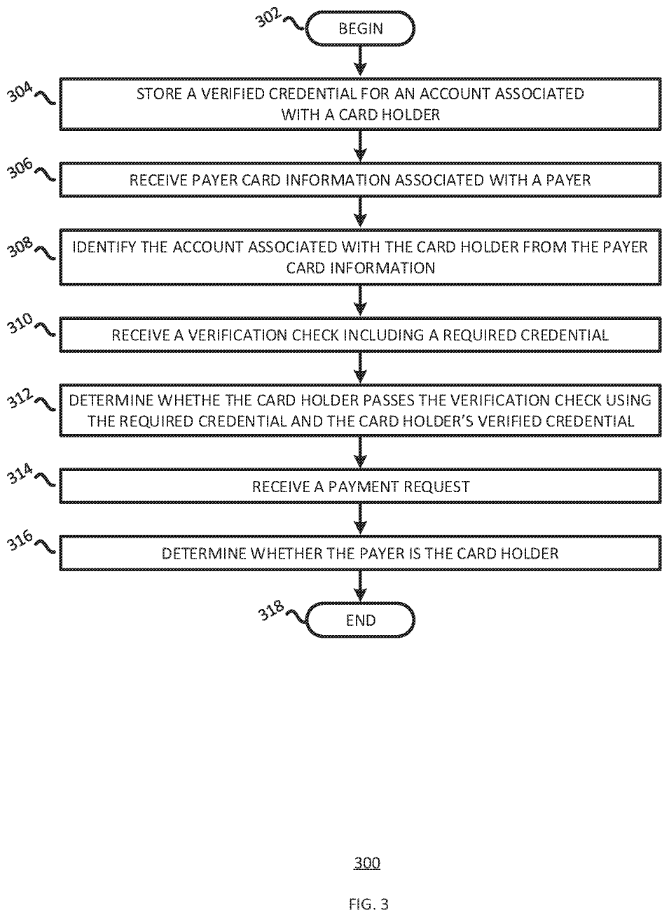

FIG. 3 is a flow chart of a method 300 for age verification, according to an example embodiment of the disclosure. Method 300 begins at block 302. At block 304, a verified credential for an account associated with a card holder can be stored. For example, a card issuer can verify a credit card applicant's date of birth as part of the process of approving the application and store the verified date of birth along with other information about the newly approved credit card account in a database containing account information for a number of credit card holders. This database can later be accessed when a credit card is presented for a transaction and matched with the appropriate credit card holder's account to find that credit card holder's verified date of birth.

At block 306, payer card information associated with a payer can be received. A point of sale terminal in a merchant system can receive card information from a payer when, for example, the payer swipes a credit card on the point of sale terminal. The point of sale terminal can receive card information such as a credit card number, a card expiration date, a billing address, a card security code, a payment amount, a location, a merchant code, and other information. The merchant system can communicate the card information to a server using a transaction communication link.

At block 308, the account associated with the card holder from the payer card information can be identified. After the server receives the payer card information from the merchant system via the transaction communication link, the server can access a database containing card holder accounts and identify the card holder account that matches the payer card information.

At block 310, a verification check including a required credential can be received. While the server is in the process of processing the transaction via the transaction communication link to the merchant system, the server can process the verification check via the verification link to the merchant system. The server can receive a required credential such as a required age as part of the verification check request from the merchant system. For example, a payer at a grocery store who is buying cigarettes among other items, may swipe a payment card in a point of sale terminal in a merchant system. The merchant system can scan a barcode on the cigarettes and the merchant system can be alerted that cigarettes are an age-restricted item and send the age verification check to the server. Either the merchant system or the server can determine the required age based on type of item, the location of the sale, and the merchant, and other information.

At block 312, it can be determined whether the card holder passes the verification check using the required credential and the card holder's verified credential. The server can access card holder account information in a database and locate the appropriate card holder account that matches the payer card information received from the merchant system. The server can perform the verification check using the matching card holder account information and determine whether the verified credential passes or fails the verification check. The server can send the pass or fail result of the verification check to the merchant system via the verification link.

At block 314, a payment request can be received. The server can receive a request for payment from the merchant system via the transaction communication link. For example, a clerk at a grocery store finishes scanning all the items, including one or more age-restricted items and the merchant system calculates the total amount due. The customer at the grocery store had scanned their card while they were waiting for the clerk and the card information had been received from the merchant system by the server via the transaction communication link.

At block 316, it can be determined whether the payer is the card holder, in response to the payment request. In the grocery store scenario, the server may have already determined that the payer was the card holder when the payer swiped their card or the server may determine this in response to the payment request or confirm that the earlier determination is correct. Method 300 ends at block 318.

In method 300, prior to receiving the payment request at block 314, a notification of whether the card holder passes the age verification check can be sent. In the grocery store scenario, the server can send a pass or fail notification in response to the age verification check request from the merchant system via the verification communication link. The server can process the transaction via the transaction communication link in parallel with processing the age verification check via the verification communication link and send the age verification notification quickly so that it is received by the merchant system before the transaction is completed and payment is requested. If, for example, the age verification check fails, the total purchase price can be reduced by the price of the age-restricted item on the merchant system or the merchant system can prompt the clerk to manually check the payer's age.

In method 300, the verified credential can be a verified date of birth, the verification check can be an age verification check, and the required credential can be a required age. For example, a card issuer can receive a driver's license number on an application for a card. The card issuer or a third party verifier can verify the driver's license number and cross-check this information with other identification information, such as a birth certificate, social security number, address, and so on. After issuing a card, the card issuer can communicate with a backend server using an API to store the verified credential and other information in an account for the new card holder. Then, the verified credential can be available for later age verification checks. An age verification check and the required age can be received by the backend server from a merchant system using an API and a verification communication link.

In method 300, the verified credential can be a verified identification credential, the verification check can be an identity check, and the required credential can be a required identity. For example, a building access card issuer can receive a new employee's identification number, after the human resources department has verified the new employee's identity and stored the verified identification credential in a data storage using an API to communicate with a server. The building access card issuer, for example, a facilities manager, can use the API to test access to the building for the new employee. The building access card can also be used to make purchases in the building food court or cafeteria or provide an employee discount for goods and services based on the employee's verified identification credential.

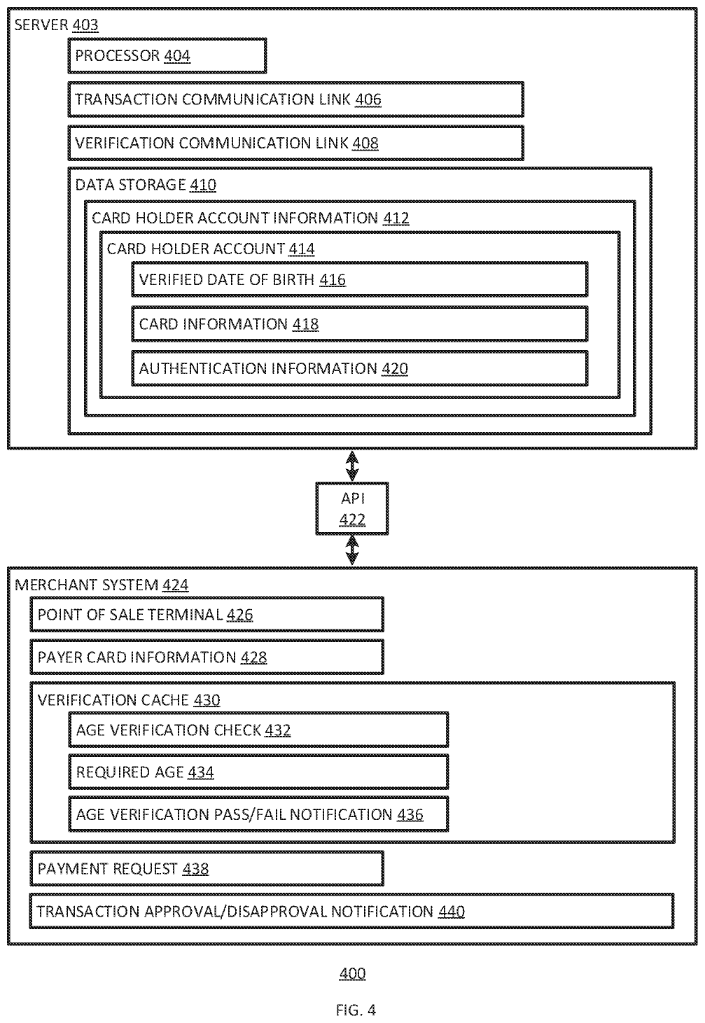

FIG. 4 is a diagram of a system 400 for age verification, according to an example embodiment of the disclosure. System 400 comprises a server 403, a merchant system 424 and an API 422. Server 403 and merchant system 424 can be network-enabled computers. Server 403 can include a processor 404, a transaction communication link 406, a verification communication link 408, and a data storage 410. Data storage 410 can be an organized collection of data stored in a memory such as a relational database. Data storage 410 can be part of server 403 or accessible by server 403. Data storage 410 can store card holder account information 412. Card holder account information 412 can include a number of card holder accounts such as card holder account 414 with a verified date of birth 416, card information 418, and authentication information 420.

Merchant system 424 can include a point of sale terminal 426. Point of sale terminal 426 can be any type of point of sale (POS) system such as a mobile POS, a tablet POS, a terminal POS, an online POS, a self-service kiosk POS, or a cloud-based POS. Merchant system 424 can include payer card information 428, a verification cache 430, a payment request 438, and a transaction approval/disapproval notification 440. Verification cache 430 can include an age verification check 432, a required age 434, and an age verification pass/fail notification 436. Merchant system 424 can communication with server 403 via API 422.

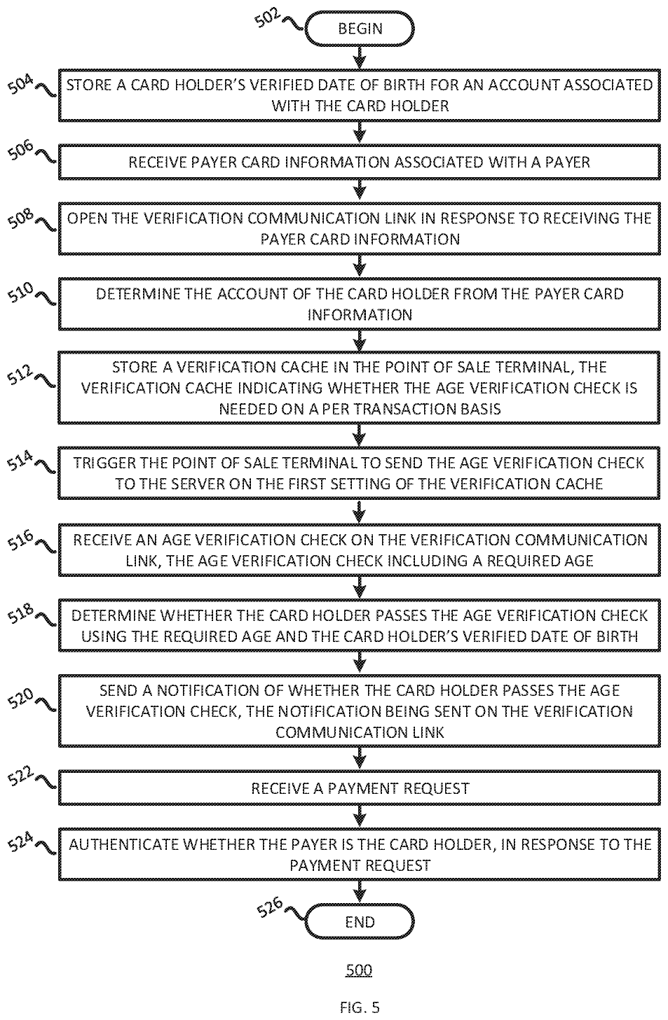

API 422 can be executable by processor 404 and in data communication with data storage 410, transaction communication link 406, and verification communication link 408. API 422 can operate to facilitate communications between merchant system 424 and server 403 using various web service protocols to exchange information such as Simple Object Access Protocol (SOAP), Remote Procedure Call (RPC), and Representational State Transfer (REST). API 422 can be configured to facilitate communication between server 403 and merchant system 424 for verifying the age at point of sale terminal 426, such as the method of FIG. 5.

FIG. 5 is a flow chart of a method 500 for age verification, according to an example embodiment of the disclosure. Method 500 begins at block 502. At block 504, a card holder's verified date of birth for an account associated with the card holder can be stored. At block 506, payer card information associated with a payer can be received. At block 508, the verification communication link can be opened in response to receiving the payer card information. At block 510, the account of the card holder can be determined from the payer card information. At block 512, the point of sale terminal can store a verification cache. The verification cache can indicate whether the age verification check is needed on a per transaction basis. At block 514, the first setting of the verification cache can trigger the point of sale terminal to send the age verification check to the server.

At block 516, an age verification check can be received on the verification communication link. The age verification check can include a required age. At block 518, it can be determined whether the card holder passes the age verification check using the required age and the card holder's verified date of birth. At block 520, a notification of whether the card holder passes the age verification check can be sent on the verification communication link. At block 522, a payment request can be received.

At block 524, it can be authenticated whether the payer is the card holder, in response to the payment request. The age verification check can include a merchant location and authenticating whether the payer is the card holder can include receiving a payer location from a mobile device and comparing the payer location with the merchant location. It can be determined whether the payer is the card holder by two-factor authentication. It can be determined whether the payer is the card holder by authentication by a parent when the parent is the card holder and the payer is a child, when the parent is in a different location from the child. It can be determined whether the payer is the card holder using a biometric test such as a fingerprint from a sensor on a card or a point of sale terminal. The verification check can be a code identifying the required credential. Method 500 ends at block 526.

In method 500, the verification check can comprise inventory data and a merchant location and the required credential can be interpreted using the inventory data and the merchant location. For example, a server can include business logic that interprets information received from a merchant system. The merchant system may, for example, scan the barcode on items during checkout and send inventory codes for a product known to have age restrictions along with the location of the merchant. The business logic may interpret this information in light of current laws and regulations for where the merchant is located in order to determine the required age. If a new law raises the age for purchasing tobacco products to 21, the business logic can use 21 years old as the required age for a tobacco product in verification, even if the merchant system has wrong, outdated or missing information about the required age.

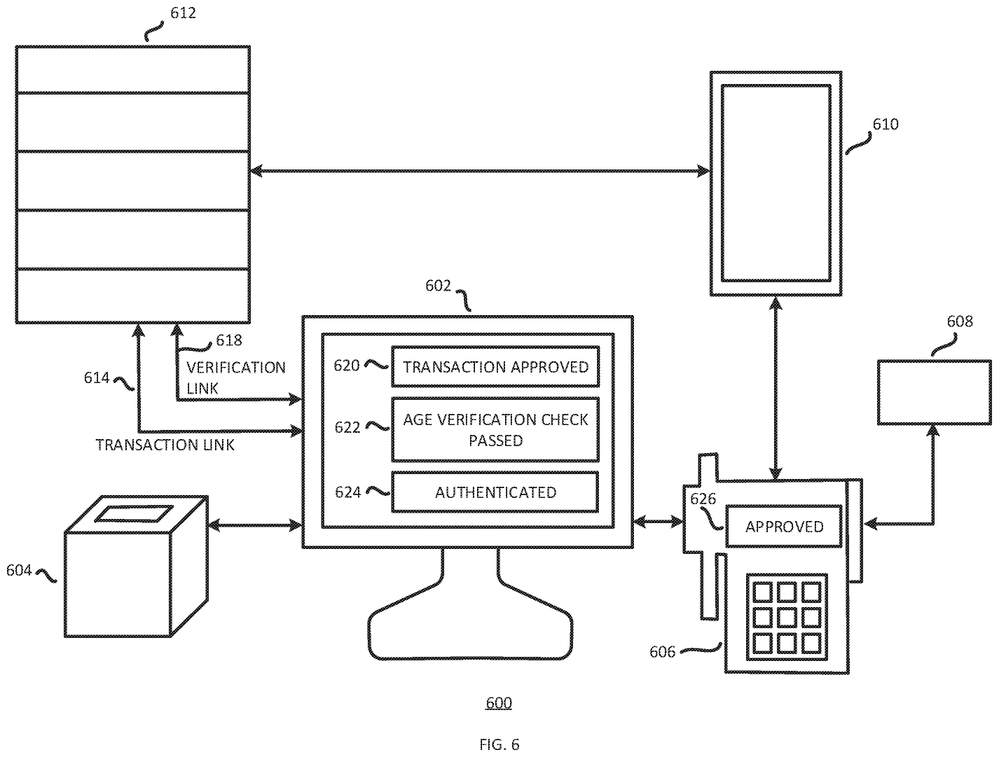

FIG. 6 is a diagram of a system 600 for age verification, according to an example embodiment of the disclosure. System 600 can be a point of sale system for a retail store, such as a mom-and-pop or national chain supermarket. System 600 can include hardware, software, networking, payment options and technical support for the retail store. System 600 includes a merchant system 602, a barcode scanning device 604, a customer system 606, a payment card 608, a customer mobile device 610, and a server 612.

For example, barcode scanning device 604 can scan items for a customer in line at a supermarket. While the customer is in line, the customer can swipe payment card 608 in customer system 606 and, in response, merchant system 602 can send a transaction approval request to server 612 via a transaction link 614. As items are scanned, merchant system 602 can identify an age-restricted product and send an age verification request over a verification link 618 to server 612. As part of the transaction approval process, server 612 can request and receive authentication from customer mobile device 610. Merchant system 602 can display transaction approved 620, age verification check passed 622, and authenticated 624 responses from server 612. Customer system 606 can display to the customer that the transaction is approved 626.

System 600 can perform an age verification check automatically without slowing down the transaction approval process. Server 612 can determine that the customer making the transaction with payment card 608 is the owner of the account association with payment card 608. When the account holder applied for the account and was approved, a rigorous screening can be conducted, including sophisticated proof and verification of identity and age along other information can be stored by server 612 and used to automatically and efficiently verify the customer's age, without slowing down the transaction approval. When embodiments of the present disclosure are implemented, a customer need to comply with repeated verifications when making age-restricted product purchases. Merchants can rely on the rigorous and sophisticated screening and approval of the card issuer rather than manually checking a customer identification, which could be fake. In addition, authentication of the transaction by the customer can prove that the customer is the account holder, adding additional security, reassurance, and convenience.

With automatic age verification built into system 600, fraudulent or mistaken purchases can be prevented. For example, while a clerk may not do an age verification check based on knowing a customer and having checked during past purchases, system 600 will quickly and automatically check without any inconvenience. System 600 can include various payment types and payment methods in addition to payment card 608. Server 612 can perform age verification and transaction approval for merchant system 602 using account information stored in a database. System 600 can be used for a self-checkout stand. Merchant system 602 can include additional features such as inventory tracking, payroll, and marketing and sales analytics. The age verification and transaction verification can be done in either order or in parallel by system 600 using transaction link 614 and verification link 618. If the age verification check fails, then merchant system 602 can notify the clerk and allow flexible processing, such as voiding the item, reducing the total purchase price by the restricted item's price, doing a manual age verification check, repeating the age verification check, or some other action. An alert on merchant system 602 that the age verification check was passed could be omitted and simply the alert that the transaction was approved can suffice. Authentication can be performed randomly, on occasion, in different ways or done more than once or in different ways in suspicious cases.

Systems and methods according to example embodiments can provide effective and efficient ways to perform age verification. In doing so, these systems and methods can meet the increasing demand for age verification with a high degree of accuracy in a quick and cost-effective manner. For example, embodiments of the present disclosure can assist a business in the diligent application of age-related laws and regulations, and in doing so can help a business avoid potential legal and regulatory issues, such as fines and forced closures, and reputational harm. Example embodiments can provide age verification in an expedient manner that does not degrade the experience of customers seeking to purchase age-restricted items or diminish the potential of a business to make sales of age-restricted items. Example embodiments of the present disclosure can also improve accuracy and reliability of age verification by reducing the potential for fake or forged identity documents to pass the verification. Example embodiments can further reduce the need for businesses to dedicate time and resources, including the time of paid personnel, to enforcing age verification.

Example embodiments of the present disclosure can benefit consumers as well as businesses. For example, by facilitating expedient age verification, the experience of consumers seeking to purchase age-restricted items can be improved, along with the experience of consumers around them (e.g., consumers waiting in line behind a person making an age-restricted purchase). By providing a more secure and accurate age verification can result in the diversion of individuals seeking to make illegitimate purchases away from the business, improving safety and reducing the need for intervention by business staff or law enforcement. Further, by reducing access by under-age individuals to age-restricted items can improve the general health and safety of those individuals. As another example, age verification according to example embodiments can reduce the need for consumers to present identification or other sensitive personal information in public or to business personnel, which can reduce the risk of identity theft and fraud.

It is understood that the present disclosure is not limited to particular types of age-restricted products or services or to a particular age, and that example embodiments of the present disclosure can apply to any type of product or services or any age restriction. It is further understood that the present disclosure can be applied to verifications and restrictions based on characteristics other than age, including without limitation identity (e.g., name, social security number), place of residence (e.g., city, county, state), citizenship, membership (e.g., club membership, loyalty program membership), and status identifiers (e.g., gold-level member, silver-level member).

In this description, numerous specific details have been set forth. It is to be understood, however, that implementations of the disclosed technology can be practiced without these specific details. In other instances, well-known methods, structures and techniques have not been shown in detail in order not to obscure an understanding of this description. References to “some examples,” “other examples,” “one example,” “an example,” “various examples,” “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described can include a particular feature, structure, or characteristic, but not every implementation necessarily includes the particular feature, structure, or characteristic. Further, repeated use of the phrases “in one example,” “in one embodiment,” or “in one implementation” does not necessarily refer to the same example, embodiment, or implementation, although it could.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, including the best mode, and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system, comprising:
a server having a processor and a transaction communication link;
a data storage accessible by the server that stores card holder account information; and
an application programming interface executable by the processor and in data communication with the data storage and the transaction communication link, the application programming interface configured to:
store a card holder's verified date of birth for an account associated with the card holder;
receive payment information from a merchant system;
determine the account associated with the card holder from the payment information;
receive age verification information including a required age from the merchant system;
determine whether the card holder's date of birth is older than the required age by comparing the required age to the card holder's verified date of birth;
receive a payment request including an amount and the payment information; and
in response to the payment request, indicate to the merchant system whether the card holder's date of birth is older than the required age by denying the payment request if the card holder's date of birth is not older than the required age.

2. The system of claim 1, wherein the server further comprises:
a verification communication link,
wherein the application programming interface has access to the verification communication link and is further configured to:
open the verification communication link in response to receiving the payment information; and
wherein the age verification information is received on the verification communication link.

3. The system of claim 2, wherein the application programming interface is further configured to:
send the indication to the merchant system via the verification communication link.

4. The system of claim 2, wherein the server is connected by the transaction communication link to the merchant system.

5. The system of claim 4, wherein the merchant system includes a point of sale terminal.

6. The system of claim 5, wherein the server is connected by the verification communication link to the point of sale terminal.

7. The system of claim 6, wherein the point of sale terminal stores a verification cache, the verification cache indicating whether an age verification check is needed on a per transaction basis.

8. The system of claim 7, wherein a first setting of the verification cache triggers the point of sale terminal to send the age verification check to the server.

9. A method, comprising:
storing a verified credential for an account associated with a card holder;
receiving payer card information associated with a payer;
identifying the account associated with the card holder from the payer card information;
receiving a verification check including a required credential;
determining whether the card holder passes the verification check using the required credential and the card holder's verified credential;
receiving a payment request; and
determining whether the payer is the card holder, in response to the payment request.

10. The method of claim 9, further comprising:
prior to receiving the payment request, sending a notification of whether the card holder passes the verification check.

11. The method of claim 9, wherein the verified credential is a verified date of birth, the verification check is an age verification check, and the required credential is a required age.

12. The method of claim 9, wherein the verified credential is a verified identification credential, the verification check is an identity check, and the required credential is a required identity.

13. The method of claim 9, wherein the verification check comprises inventory data and a merchant location and the method further comprises:
interpreting the required credential using the inventory data and the merchant location.

14. The method of claim 11, wherein the age verification check includes a merchant location and further wherein authenticating whether the payer is the card holder further comprises receiving a payer location from a mobile device and comparing the payer location with the merchant location.

15. The method of claim 9, wherein determining whether the payer is the card holder comprises two-factor authentication.

16. The method of claim 15, wherein determining whether the payer is the card holder comprises authentication by a parent when the parent is the card holder and the payer is a child, the parent being in a different location from the child.

17. The method of claim 15, wherein determining whether the payer is the card holder comprises a biometric test.

18. The method of claim 17, wherein the biometric test comprises a fingerprint.

19. The method of claim 9, wherein the verification check is a code identifying the required credential.

20. A system, comprising:
a server having a processor, a transaction communication link, and a verification communication link, the transaction communication link and the verification communication link being connected to a merchant system;
a data storage accessible by the server that stores card holder account information;
an application programming interface executable by the processor and in data communication with the data storage, the transaction communication link, and the verification communication link, the application programming interface configured to:
store a card holder's verified date of birth for an account associated with the card holder;
receive payer card information associated with a payer;
open the verification communication link in response to receiving the payer card information;
determine the account of the card holder from the payer card information;
receive an age verification check on the verification communication link, the age verification check including a required age;
determine whether the card holder passes the age verification check using the required age and the card holder's verified date of birth;
send a notification of whether the card holder passes the age verification check, the notification being sent on the verification communication link;
receive a payment request; and
authenticate whether the payer is the card holder, in response to the payment request,
wherein the merchant system includes a point of sale terminal that stores a verification cache, the verification cache indicating whether the age verification check is needed on a per transaction basis; and
wherein a first setting of the verification cache triggers the point of sale terminal to send the age verification check to the server.
